(19) United States
(12) Patent Application Publication
(10) Pub. No.: US 2008/0007522 A1
(43) Pub. Date: Jan. 10, 2008

(54) Multiple-evaluator input device

(76) Inventor: Howard E. Rhett, Amherst, MA (US)

Correspondence Address: MENDELSOHN AND ASSOCIATES, P.C., 1500 JOHN F. KENNEDY BLVD., SUTIE 405, PHILADELPHIA, PA, 19102, US

(21) Appl. No.: 11/371,697

(22) Filed: Mar. 9, 2006

Related U.S. Application Data
(60) Provisional application No. 60/660,105, filed on Mar. 9, 2005.

(51) Int. Cl. G09G 5/08

(52) U.S. Cl. 345/163

(57) ABSTRACT

A system for controlling a software application employing a plurality of soft evaluators of at least first and second types. Each soft evaluator is (i) displayed as a graphical item and (ii) represents an interface for controlling a function in the software application. The system includes an input device and a machine-readable medium. The input device has a plurality of hardware evaluators of at least the first and second types. Different types of motion are associated with the first and second types of hardware evaluators. The machine-readable medium has encoded thereon program code. When the program code is executed by a machine that also executes the software application, the machine is adapted to: (i) enable a user to select a first soft evaluator of the first type; (ii) map the first soft evaluator to a first hardware evaluator of the first type such that motion applied by the user to the first hardware evaluator controls the function represented by the first soft evaluator; (iii) enable the user to select a second soft evaluator of the second type; and (iv) map the second soft evaluator to a second hardware evaluator of the second type such that motion applied by the user to the second hardware evaluator controls the function represented by the second soft evaluator.

### CROSS-REFERENCE TO RELATED APPLICATION

This application claims the benefit of the filing date of U.S. provisional application No. 60/660,105, filed on Mar. 9, 2005 as attorney docket no. 1107.001PROV, the teachings of which are incorporated herein by reference.

### BACKGROUND OF THE INVENTION

1. Field of the Invention

The present invention relates generally to input devices, and, more particularly, to a hardware input device that controls various functions in a software application (e.g., a flight simulator) running on a processor-based computing device.

2. Description of the Related Art

Virtual reality computing and gaming applications typically display a virtual environment to a user that appears to the user as a visually “real environment.” The virtual image or image signal is generated by a computer that allows a user to act as if in the virtual environment. Applications for virtual reality include, e.g., video gaming, entertainment, military training simulations, law enforcement training simulations, fire fighter training simulations, space simulations, flight simulations, science education simulations, and various medical, architectural, and design applications. Recently, virtual reality systems have included 3-dimensional graphics images and increased detailed computer graphics utilizing millions of polygons, which make the virtual world appear more realistic and immersive.

Navigating a virtual environment, i.e., causing changes in the virtual images (e.g., by piloting an aircraft) is typically achieved using standard, or sometimes customized, input devices, which may include one or more of, e.g., a joystick, a keyboard, a mouse, a trackball, a touchpad, a toggle switch, a button, a knob, a slider, a rolling wheel, a rocker, a dial, and a push-pull switch. Such user inputs control the operation of a virtual reality application so as to direct the image construction and presentation of the virtual reality images to the user.

Existing user input devices are often limited in their abilities to (i) mimic faithfully their corresponding controls in virtual reality applications and (ii) provide a user with a virtual reality environment that seems realistic.

FIG. 1 illustrates a standard three-button mouse 100 that might be used in conjunction with a software application, such as a flight-simulator application. Mouse 100 has three buttons 101, 102, 103 and a mouse body 104. Mouse 100 supplies input values to a software application on a computer to which it is coupled to control the operation of the application. Such control is effected by one or more of a user's (i) manipulation of body 104 in the left-and-right (x) and/or up-and-down (y) directions along the plane of a work surface upon which mouse 100 is disposed and (ii) depression or release of one or more of the three buttons 101, 102, 103. The displacement of mouse 100 is detected, e.g., by an optical transmitter-receiver pair or a mechanical sensor (not shown), such as a mouse ball, disposed on the underside of mouse 100. Mouse 100 transmits signals corresponding to the state of buttons 101, 102, 103 and the relative displacement of mouse body 104 to the computer to which it is coupled (e.g., via USB interface or serial connection) to control various functions of the software application.

As used herein, the term “evaluator” refers to a software or hardware control device that permits adjustment of a given variable or function in a hardware device or software application (in the context of the present invention, typically the latter). Hardware evaluators are physical controls that are used to alter values or activate functions in a hardware device, e.g., a volume knob or a brightness slider on a laptop computer. Soft evaluators are typically software-generated representations of knobs, buttons, dials, sliders, rockers, and other types of switches and related devices that are displayed on-screen in a software application and are typically selected and manipulated using a keyboard and/or mouse. Based on the keyboard and/or mouse input, the software graphically alters the on-screen appearance of a soft evaluator, as though the user were physically manipulating the evaluator on a hardware device, while the software concomitantly alters the value of the underlying variable or activates the underlying function.

Due to the complexities of aircraft instrumentation, which many flight simulators replicate quite faithfully, a typical flight-simulator application employs tens or even hundreds of different evaluator inputs of various types to control the various functions of the simulation. FIG. 2 illustrates a partial screen view of an exemplary flight-simulator application replicating a panel 200 of aircraft instrumentation. As shown, panel 200 comprises a plurality of soft evaluators (e.g., 201-1, 201-2, 201-3, 202-1, 202-2, 202-3, 203-1, 203-2, 203-3) in a simulated aircraft representing corresponding hardware evaluators in a real aircraft. The soft evaluators are of various types, including push-pull switches 201-1, 201-2, 201-3, dial knobs 202-1, 202-2, 202-3, and rocker switches 203-1, 203-2, 203-3.

When mouse 100 of FIG. 1 (or other standard mouse, trackball, touchpad, joystick, or other similar input device) is used in conjunction with panel 200 of the flight-simulator application to control its soft evaluators, the user first “wands” or “mouses over” the soft evaluator that the user wishes to control, i.e., moves mouse body 104 so that the on-screen cursor is located over or proximal to the desired soft evaluator (in some applications, the user must also depress one of mouse buttons 101, 102, 103 to “lock onto” a soft evaluator before manipulating it). Next, the user uses mouse 100 to manipulate the soft evaluator. This might occur in several ways, depending on the software application and the type of soft evaluator.

For example, if the soft evaluator is a switch having two or more states (e.g., as with push-pull switches 201-1, 201-2, 201-3, rocker switches 203-1, 203-2, 203-3, or dial knobs or sliders having multiple stop or click positions), the user might change the state of the switch (e.g., toggle its state or cycle through its states) by simply depressing a certain one of mouse buttons 101, 102, 103. The user might also be able to cycle through the same states in reverse order by depressing a different one of mouse buttons 101, 102, 103. Alternatively, two or more of the mouse buttons 101, 102, 103 might each represent a different state, such that the user depresses a first one of mouse buttons 101, 102, 103 to activate a first state, a second one of mouse buttons 101, 102, 103 to activate a second state, etc. Another alternative might be for the user to move mouse body 104 either up/down or left/right to toggle the states or cycle through the states in forward/reverse order.

As another example, if the soft evaluator has a range of values (e.g., as with dial knobs 202-1, 202-2, 202-3, sliders, or vernier knobs), after mousing over the soft evaluator (and possibly depressing one of mouse buttons 101, 102, 103 to “lock onto” the evaluator, as the application may require), the user might move mouse body 104 either up/down or left/right to increase/decrease the value of the evaluator within the given range.

Software functionality for the foregoing described control methods using a standard mouse is typically provided by the flight-simulator application itself, which is preconfigured to operate in this manner.

When using mouse 100 (or other standard mouse) with a flight-simulator application as described above, the user disadvantageously lacks the ability to control soft evaluators with the same precision as would be possible using the actual hardware evaluators that the soft evaluators represent. For example, depending on the sensitivity settings of the mouse software driver and application interface, the user relies on his or her own fine up/down or left/right motor manipulation of mouse body 104. Moreover, the simulation experience may experience degradation due to a lack of realism in instrumentation. One solution to this problem is to purchase and use one or more customized input devices, such as various modules manufactured by GoFlight, Inc. of Beaverton, Oreg., which contain a plurality of dedicated hardware evaluators corresponding to the on-screen soft evaluators. These customized modules, a plurality of which can be used concurrently (e.g., via a USB interface), map dedicated hardware evaluators to soft evaluators with a one-to-one correspondence. Thus, for example, a dial knob labeled “heading” on the input device controls a soft evaluator dial knob labeled “heading” on-screen; a toggle switch labeled “landing gear” on the input device controls a soft evaluator toggle switch labeled “landing gear” on-screen; etc. The obvious disadvantage of this arrangement is that a large number of customized and costly hardware input devices are necessary to replicate the large number of evaluators in the simulator.

### SUMMARY OF THE INVENTION

Problems in the prior art are addressed in accordance with the principles of the present invention by providing a hardware input device that uses a relatively small number of hardware evaluators to permit adjustment of a larger number of software evaluators controlling various functions in a software application, such as a flight simulator.

In one embodiment, the present invention provides a system for controlling a software application employing a plurality of soft evaluators of at least first and second types. Each soft evaluator is (i) displayed as a graphical item and (ii) represents an interface for controlling a function in the software application. The system includes an input device and a machine-readable medium. The input device has a plurality of hardware evaluators of at least the first and second types. Different types of motion are associated with the first and second types of hardware evaluators. The machine-readable medium has encoded thereon program code. When the program code is executed by a machine that also executes the software application, the machine is adapted to: (i) enable a user to select a first soft evaluator of the first type; (ii) map the first soft evaluator to a first hardware evaluator of the first type such that motion applied by the user to the first hardware evaluator controls the function represented by the first soft evaluator; (iii) enable the user to select a second soft evaluator of the second type; and (iv) map the second soft evaluator to a second hardware evaluator of the second type such that motion applied by the user to the second hardware evaluator controls the function represented by the second soft evaluator.

In another embodiment, the present invention provides a machine-readable medium for a system for controlling a software application employing a plurality of soft evaluators of at least first and second types. Each soft evaluator is (i) displayed as a graphical item and (ii) represents an interface for controlling a function in the software application. The system includes an input device and the machine-readable medium. The input device has a plurality of hardware evaluators of at least the first and second types. Different types of motion are associated with the first and second types of hardware evaluators. The machine-readable medium has encoded thereon program code. When the program code is executed by a machine that also executes the software application, the machine is adapted to: (a) enable a user to select a first soft evaluator of the first type; (b) map the first soft evaluator to a first hardware evaluator of the first type such that motion applied by the user to the first hardware evaluator controls the function represented by the first soft evaluator; (c) enable the user to select a second soft evaluator of the second type; and (d) map the second soft evaluator to a second hardware evaluator of the second type such that motion applied by the user to the second hardware evaluator controls the function represented by the second soft evaluator.

In a further embodiment, the present invention provides an input device for a system for controlling a software application employing a plurality of soft evaluators of at least first and second types. Each soft evaluator is (i) displayed as a graphical item and (ii) represents an interface for controlling a function in the software application. The system includes the input device and a machine-readable medium. The input device has a plurality of hardware evaluators of at least the first and second types. Different types of motion are associated with the first and second types of hardware evaluators. The machine-readable medium has encoded thereon program code. When the program code is executed by a machine that also executes the software application, the machine is adapted to: (a) enable a user to select a first soft evaluator of the first type; (b) map the first soft evaluator to a first hardware evaluator of the first type such that motion applied by the user to the first hardware evaluator controls the function represented by the first soft evaluator; (c) enable the user to select a second soft evaluator of the second type; and (d) map the second soft evaluator to a second hardware evaluator of the second type such that motion applied by the user to the second hardware evaluator controls the function represented by the second soft evaluator.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 is a perspective view of a prior-art standard three-button mouse;

FIG. 2 illustrates a screen view of an exemplary flight-simulator application replicating a panel of aircraft instrumentation;

FIG. 3 is a perspective view of an exemplary input device consistent with a first embodiment of the present invention;

FIG. 4 is a plan view of an exemplary input device consistent with a second embodiment of the present invention;

FIG. 5 is a perspective view of an exemplary input device consistent with a third embodiment of the present invention; and

FIG. 6 is a flowchart illustrating the operation of an exemplary software control program for use in conjunction with an input device consistent with various embodiments of the present invention.

### DETAILED DESCRIPTION

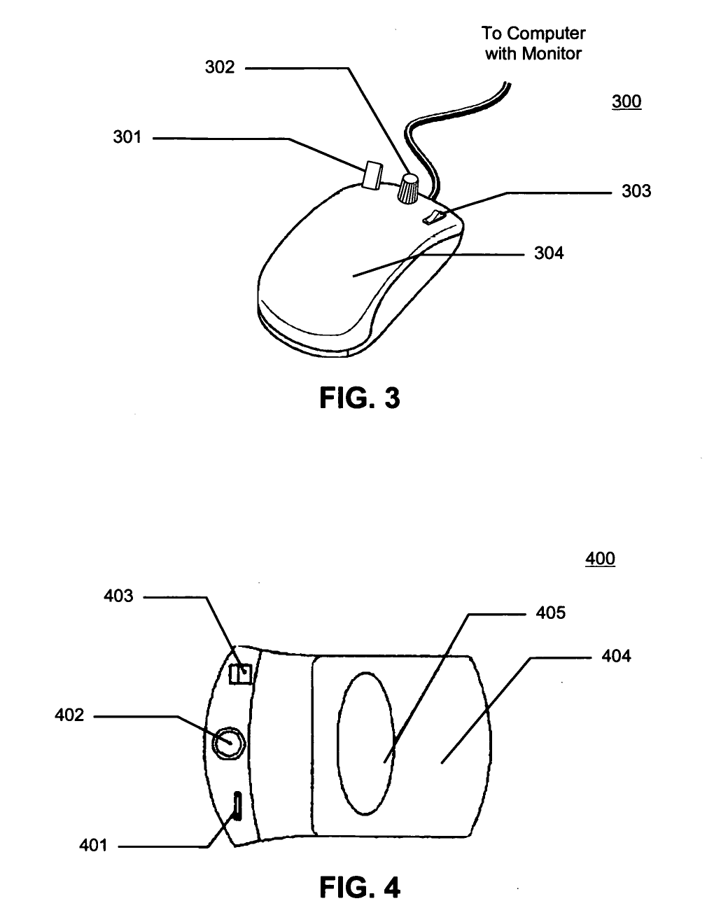

FIG. 3 illustrates an exemplary input device 300 consistent with a first embodiment of the present invention that might be used in conjunction with a software application, such as a flight-simulator application. Input device 300 has a body 304 and three hardware evaluators: a push-pull switch 301, a dial knob 302, and a rocker switch 303. Input device 300 supplies input values to a software application on a computer to which it is coupled (e.g., via USB or serial connection) to control the operation of the application. Such control is effected by one or more of a user's (i) manipulation of body 304 in the left-and-right (x-axis) and/or up-and-down (y-axis) directions along the plane of a work surface upon which input device 300 is disposed and (ii) manipulation of one or more of push-pull switch 301, dial knob 302, and rocker switch 303. The displacement of input device 300 is detected, e.g., by an optical transmitter-receiver pair or a mechanical sensor (not shown), such as a mouse ball, on the underside of input device 300. Input device 300 transmits signals corresponding to the relative displacement of body 304 and the manipulation of one or more of push-pull switch 301, dial knob 302, and rocker switch 303 to the computer to which it is coupled (e.g., via USB interface or serial connection) to control various functions of the software application.

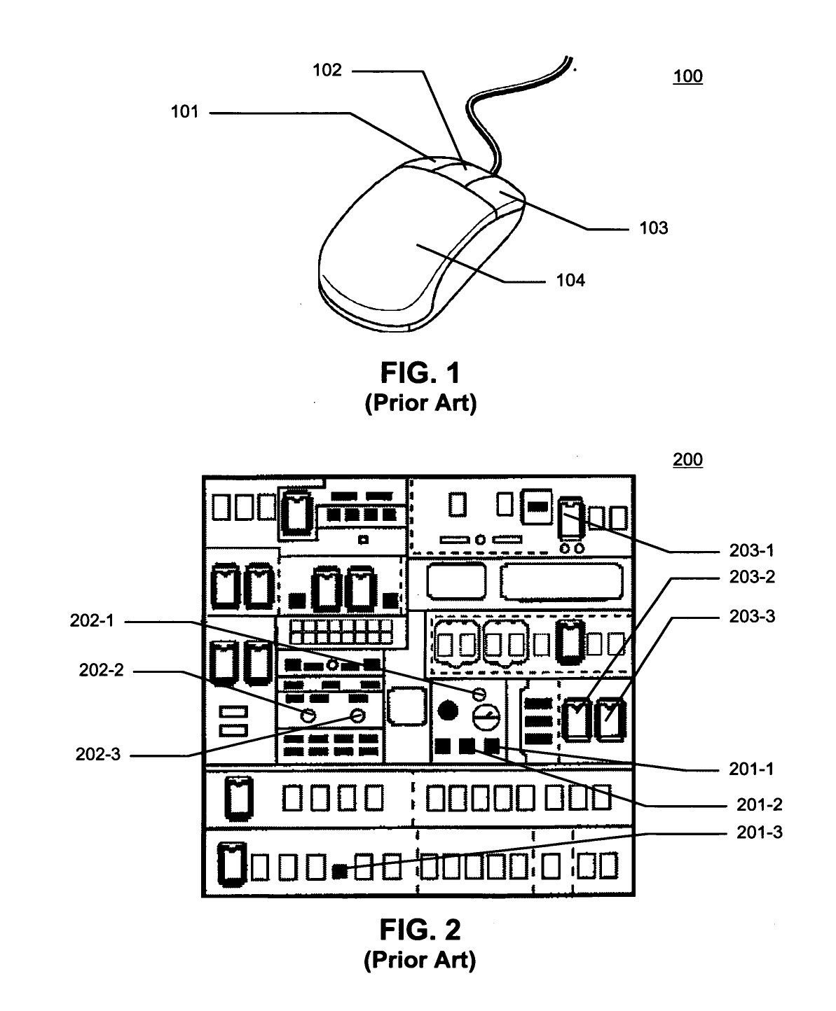

With reference again to FIG. 2, the partial screen view of an exemplary flight-simulator application replicating a panel 200 of aircraft instrumentation, panel 200 comprises a plurality of soft evaluators (e.g., 201-1, 201-2, 201-3, 202-1, 202-2, 202-3, 203-1, 203-2, 203-3) representing corresponding hardware evaluators in a simulated aircraft. In this embodiment of input device 300 (of FIG. 1), push-pull switch 301, dial knob 302, and rocker switch 303 correspond to push-pull switches 201-1, 201-2, 201-3, dial knobs 202-1, 202-2, 202-3, and rocker switches 203-1, 203-2, 203-3, respectively, of the software application.

When input device 300 is used in conjunction with panel 200 of the flight-simulator application to control its soft evaluators, the user first “wands” or “mouses over” the soft evaluator that the user wishes to control, i.e., moves body 304 so that the on-screen cursor is located over or proximal to the desired soft evaluator. Next, to manipulate the soft evaluator, the user simply manipulates the hardware evaluator 301, 302, 303 that corresponds to the soft evaluator. Thus, the same hardware evaluator can be used with a plurality of soft evaluators of the same type.

For example, if the desired soft evaluator is one of push-pull switches 201-1, 201-2, 201-3, the user pushes push-pull switch 301 to cause the desired soft evaluator to be in the “pushed” state and pulls push-pull switch 301 to cause the desired soft evaluator to be in the “pulled” state. Rocker switches 203-1, 203-2, 203-3 can be manipulated in like manner using rocker switch 303. Thus, it is desirable that push-pull switch 301 and rocker switch 203 be three-position switches biased to return to center, as opposed to being two-position switches, to avoid a conflict situation (e.g., push-pull switch 301 already being in a “pushed” state when the user mouses over a soft evaluator already in a “pulled” state).

If the desired soft evaluator is one of dial knobs 202-1, 202-2, 202-3, the user rotates dial knob 302 clockwise/counterclockwise to cause the desired soft evaluator to rotate clockwise/counterclockwise. In some embodiments, dial knob 302 rotates smoothly (e.g., to set a fine value within a range), and in other embodiments, input device 300 might include a tactile feedback mechanism so that the user feels a “click” or similar tactile feature when dial knob 302 is rotated by a predetermined number of degrees. Such a tactile feedback mechanism could be purely mechanical in some embodiments. It is also contemplated that, in other embodiments, if the corresponding soft evaluator has multiple stop or click positions (as opposed to turning smoothly to set a fine value within a range), such tactile feedback could be generated electromechanically within input device 300, e.g., using an acoustic transducer, based on signals from the software application indicating the attainment of stop or click positions.

Software functionality for the foregoing described control methods using input device 300 can be provided by a software application itself, or alternatively, by a software driver sold or distributed with input device 300.

FIG. 4 illustrates an input device 400 consistent with a second embodiment of the present invention. Input device 400 is similar to input device 300 and contains features 401-404 that correspond to features 301-304. Input device 400 also includes a scroll area 405 (or touchpad) that can be used, e.g., to manipulate an on-screen cursor to select a desired soft evaluator. While scroll area 405 may be provided instead of a mouse ball or optical transmitter-receiver pair, scroll area 405 may alternatively be provided in conjunction with a mouse ball or optical transmitter-receiver pair, whereby scroll area 405 controls the cursor, and movement of body 404 provides one or more other functions (e.g., aileron and pitch control), or vice-versa.

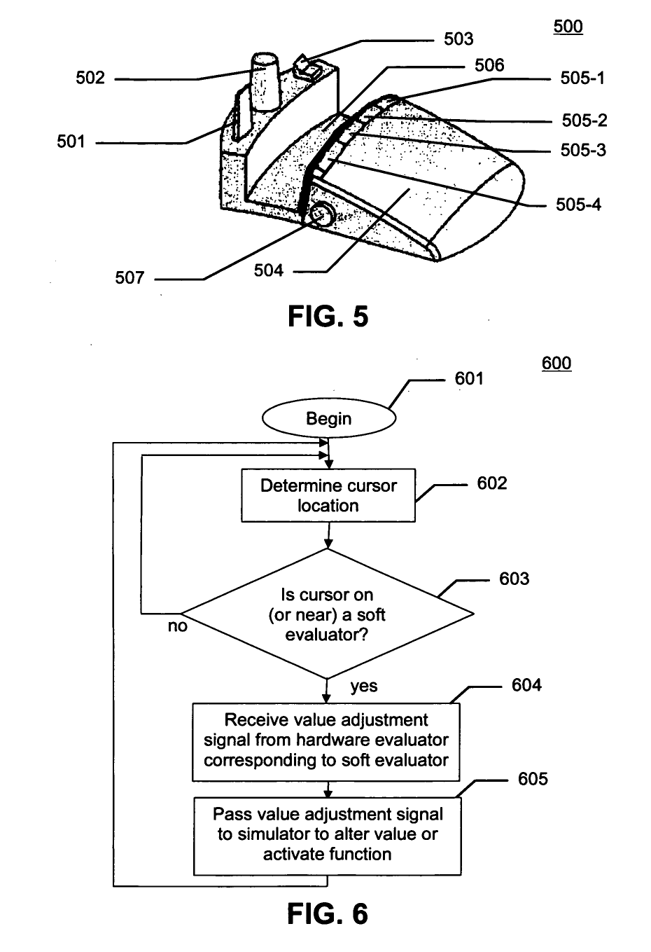

FIG. 5 illustrates an input device 500 consistent with a third embodiment of the present invention. Input device 500 is similar to input device 300 and contains features 501-504 that correspond to features 301-304. Input device 500 also includes a set of four sliders 505-1, 505-2, 505-3, 505-4 disposed adjacent to a recess 506 and an assignable button 507. Sliders 505-1, 505-2, 505-3, 505-4 might be used to control a plurality of sets of (four or fewer) soft-evaluator sliders present in a flight simulator, e.g., for throttle control of up to four engines. In FIG. 5, each of sliders 505-1, 505-2, 505-3, 505-4 is a button, such that, when input device 500 mouses over a corresponding set of soft-evaluator sliders, the user can click and hold one or more of sliders 505-1, 505-2, 505-3, 505-4 while moving body 504 up/down to control one or more of the corresponding soft-evaluator sliders. Alternatively, sliders 505-1, 505-2, 505-3, 505-4 could comprise hardware up/down mechanical sliders, such that, when input device 500 mouses over a corresponding set of soft-evaluator sliders, the user can slide one or more of sliders 505-1, 505-2, 505-3, 505-4 up/down to control one or more of the corresponding soft-evaluator sliders. Assignable button 507 is a standard programmable mouse button that can be assigned to various functions, e.g., left-click.

FIG. 6 is a flowchart illustrating an exemplary software control program for use with an input device consistent with various embodiments of the present invention. As shown, the method begins at step 601. At step 602, the software queries the current cursor location. At step 603, a determination is made whether the cursor is on or proximal to an on-screen soft evaluator. If not, then the method returns to step 602. If, at step 603, it is determined that the cursor is on or proximal to an on-screen soft evaluator, then, at step 604, the software receives as input a value adjustment (or similar) signal from the hardware evaluator corresponding to the on-screen soft evaluator. At step 605, the software passes the value adjustment signal (or another signal based thereon) to the simulator, which concomitantly (i) graphically alters the soft evaluator and (ii) alters the value of the underlying variable or activates the underlying function. The method then returns to step 602.

While the foregoing input device embodiments are described as employing a mouse for cursor control, it should be understood that another control device could alternatively be used, such as a trackball, a joystick, or a touchpad. Likewise, nearly any control device that a user can manipulate could be used as a hardware evaluator in various embodiments of the present invention. Such control devices include, e.g., a joystick, a set of one or more keys, a trackball, a touchpad, a toggle switch, a button, a knob, a slider, a lever, a rolling wheel, a rocker, a dial, and a push-pull switch.

An input device consistent with the present invention might also include other features not specifically described above. For example, the input device might include two or three standard mouse buttons in addition to a plurality of hardware evaluators. Such standard buttons might be used in an input device consistent with certain embodiments of the present invention, e.g., to control one or more soft evaluator types for which no corresponding hardware evaluator exists.

While selection of an on-screen soft evaluator using an input device consistent with the present invention is described as being made by the user first “wanding” or “mousing over” the soft evaluator that the user wishes to control, other methods of selection are possible, e.g., using directional keys on a keyboard, voice-activated controls, or other control device.

While the on-screen cursor is described as being generally located over or proximal to a desired soft evaluator, the necessary distance between the cursor and the soft evaluator to effect selection may vary in certain embodiments of the present invention. This distance may be selectable by a user in a software application or a software driver used in conjunction with an input device consistent with certain embodiments of the present invention,

As described above, various embodiments of the present invention may include one or more control software routines or drivers for interfacing with a software application, such as a simulator. Such software routines may reside in a memory device contained within the input device, on a separate magnetic, optical, or electronic memory medium, and/or on a computer system running the software application.

Software applications with which various embodiments of the present invention may be used include both simulators and non-simulator applications including, e.g., video gaming, entertainment, military training simulations, law enforcement training simulations, fire fighter training simulations, space simulations, flight simulations, science education simulations, and various medical, architectural, and design applications.

The present invention may include circuit-based processes, which may be included as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer.

The present invention can be embodied in the form of methods and apparatuses for practicing those methods. Some portions of the present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. Portions of the present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments.

It will be further understood that various changes in the details, materials, and arrangements of the parts which have been described and illustrated in order to explain the nature of this invention may be made by those skilled in the art without departing from the scope of the invention as expressed in the following claims.

I claim:

1. A system for controlling a software application employing a plurality of soft evaluators of at least first and second types, each soft evaluator (i) displayed as a graphical item and (ii) representing an interface for controlling a function in the software application, the system comprising:
an input device having a plurality of hardware evaluators of at least the first and second types, wherein different types of motion are associated with the first and second types of hardware evaluators; and
a machine-readable medium having encoded thereon program code, wherein, when the program code is executed by a machine that also executes the software application, the machine is adapted to:
enable a user to select a first soft evaluator of the first type;
map the first soft evaluator to a first hardware evaluator of the first type such that motion applied by the user to the first hardware evaluator controls the function represented by the first soft evaluator;
enable the user to select a second soft evaluator of the second type; and
map the second soft evaluator to a second hardware evaluator of the second type such that motion applied by the user to the second hardware evaluator controls the function represented by the second soft evaluator.

2. The invention of claim 1, wherein the machine is further adapted to:
enable the user to select a third soft evaluator of the first type; and
map the third soft evaluator to the first hardware evaluator such that motion applied by the user to the first hardware evaluator controls the function represented by the third soft evaluator.

3. The invention of claim 1, wherein the input device further comprises an interface for selecting each soft evaluator.

4. The invention of claim 3, wherein:
the interface is one of a mouse, a touchpad, a trackball, and a joystick; and
the plurality of hardware evaluators comprises two or more of a joystick, a set of one or more keys, a trackball, a touchpad, a toggle switch, a button, a knob, a slider, a lever, a rolling wheel, a rocker, a dial, and a push-pull switch.

5. The invention of claim 4, wherein the input device further comprises one or more additional interfaces for controlling one or more additional functions in the software application.

6. The invention of claim 1, wherein the machine is adapted to enable the user to select each soft evaluator by controlling two-dimensional movement of a displayed cursor to be proximal to the selected soft evaluator.

7. The invention of claim 1, wherein the graphical item displayed for each soft evaluator visually resembles the mapped hardware evaluator.

8. The invention of claim 1, wherein the input device comprises a tactile feedback mechanism associated with one of the hardware evaluators.

9. The invention of claim 1, wherein the machine is adapted to permit a user to adjust more than one evaluator concurrently by concurrently adjusting more than one hardware evaluator.

10. The invention of claim 1, wherein the input device further comprises one or more additional evaluators that are user-programmable.

11. A machine-readable medium for a system for controlling a software application employing a plurality of soft evaluators of at least first and second types, each soft evaluator (i) displayed as a graphical item and (ii) representing an interface for controlling a function in the software application, the system comprising:
an input device having a plurality of hardware evaluators of at least the first and second types, wherein different types of motion are associated with the first and second types of hardware evaluators; and
the machine-readable medium having encoded thereon program code, wherein, when the program code is executed by a machine that also executes the software application, the machine is adapted to:
enable a user to select a first soft evaluator of the first type;
map the first soft evaluator to a first hardware evaluator of the first type such that motion applied by the user to the first hardware evaluator controls the function represented by the first soft evaluator;
enable the user to select a second soft evaluator of the second type; and
map the second soft evaluator to a second hardware evaluator of the second type such that motion applied by the user to the second hardware evaluator controls the function represented by the second soft evaluator.

12. The invention of claim 11, wherein the machine is further adapted to:
enable the user to select a third soft evaluator of the first type; and
map the third soft evaluator to the first hardware evaluator such that motion applied by the user to the first hardware evaluator controls the function represented by the third soft evaluator.

13. The invention of claim 11, wherein the machine is adapted to enable the user to select each soft evaluator by controlling two-dimensional movement of a displayed cursor to be proximal to the selected soft evaluator.

14. The invention of claim 11, wherein the graphical item displayed for each soft evaluator visually resembles the mapped hardware evaluator.

15. The invention of claim 11, wherein the machine is adapted to permit a user to adjust more than one evaluator concurrently by concurrently adjusting more than one hardware evaluator.

16. An input device for a system for controlling a software application employing a plurality of soft evaluators of at least first and second types, each soft evaluator (i) displayed as a graphical item and (ii) representing an interface for controlling a function in the software application, the system comprising:
the input device having a plurality of hardware evaluators of at least the first and second types, wherein different types of motion are associated with the first and second types of hardware evaluators; and
a machine-readable medium having encoded thereon program code, wherein, when the program code is executed by a machine that also executes the software application, the machine is adapted to:
enable a user to select a first soft evaluator of the first type;
map the first soft evaluator to a first hardware evaluator of the first type such that motion applied by the user to the first hardware evaluator controls the function represented by the first soft evaluator;
enable the user to select a second soft evaluator of the second type; and
map the second soft evaluator to a second hardware evaluator of the second type such that motion applied by the user to the second hardware evaluator controls the function represented by the second soft evaluator.

17. The invention of claim 16, wherein the input device further comprises an interface for selecting each soft evaluator.

18. The invention of claim 17, wherein:
the interface is one of a mouse, a touchpad, a trackball, and a joystick; and
the plurality of hardware evaluators comprises two or more of a joystick, a set of one or more keys, a trackball, a touchpad, a toggle switch, a button, a knob, a slider, a lever, a rolling wheel, a rocker, a dial, and a push-pull switch.

19. The invention of claim 16, wherein the input device comprises a tactile feedback mechanism associated with one of the hardware evaluators.

20. The invention of claim 16, wherein the input device further comprises one or more additional evaluators that are user-programmable.
